(19) United States
(12) Patent Application Publication
(10) Pub. No.: US 2019/0291784 A1
(43) Pub. Date: Sep. 26, 2019

(54) VEHICLE FENDER STRUCTURE FOR EASY STORAGE AND TRANSPORTATION

(71) Applicant: Fu-Man SHIH, New Taipei City (TW)

(72) Inventor: Fu-Man SHIH, New Taipei City (TW)

(21) Appl. No.: 15/991,942

(22) Filed: May 29, 2018

(30) Foreign Application Priority Data
Mar. 21, 2018 (TW) 107203672

(51) Int. Cl. B62D 25/16; B62D 25/18

(52) U.S. Cl. CPC B62D 25/161; B62D 21/12; B62D 25/18

(57) ABSTRACT

A vehicle fender structure for easy storage and transportation comprises a plastic molded body and a positioning element. The body is in an arcuate shape and has a surface. The surface is provided thereon with a plurality of protruding parts that are of different sizes for strengthening the body. The surface has two corresponding sides respectively provided with a lateral wall. Each lateral wall is provided with a plurality of partially broken sections, and two sides of each partially broken section are respectively formed with a positioning part. In this way, when the body is pressed downwardly, the partially broken section is expanded to form a gap, by which the body's height is lowered. The positioning element is used to interconnect the two positioning parts of each partially broken section and enclose the partially broken section of the body when the body's arcuate shape is restored.

### BACKGROUND OF THE INVENTION

### Field of Invention

The present invention is related to a vehicle fender structure for easy storage and transportation, which has simple structure and is convenient to use.

### Prior Art

Conventionally, a vehicle of various kinds is usually further provided with a fender above its tire on its body in order to prevent from the splash of rainwater, dirty water, or mud and dust from the road surface during the driving of the vehicle. The splash caused by tires would be even getting worse for trucks, cars, and trailers. Particularly, for the driving of a vehicle at a high speed in rainy days, water on the road surface would be thrown backwards by the tires of the vehicle and hit its fender, so as to form spray, which would further impede the sight of the drivers of other vehicles following the vehicle. Therefore, fenders are indeed beneficial for driving safety.

A fender available currently is usually a plate in an arcuate shape made by plastic injection molding. In order to enhance the structural strength, such a plate is further provided with reinforced blocks of different shapes, sizes. By means of these reinforced blocks, when a fender is provided on the body of a vehicle above its tire, the shape of the fender could be maintained. Such structural design indeed has advantages of being able to enhance the structural strength and of being convenient to assemble. However, for the dealers of the fenders with this structural design, such design would make it disadvantageous for them to transport, store these fenders before they are released into the market. Therefore, such structural design indeed causes inconvenience.

### SUMMARY OF THE INVENTION

In view of the shortcomings mentioned above, the present invention is aimed at providing a vehicle fender structure for easy storage and transportation having following advantages: that the space required to hold it during the process of transportation or storage is reduced, and that the structural design of being in an arcuate shape is able to retain the structural strength and convenient to assemble.

An object of the present invention is to provide a vehicle fender structure for easy storage and transportation, which has simple structure and is convenient to use.

In order to achieve the above-mentioned object, the present invention provides a vehicle fender structure for easy storage and transportation comprising a plastic molded body and a positioning element. The plastic molded body is in an arcuate shape and has a surface. The surface is provided thereon with a plurality of protruding parts that are of different sizes for strengthening the plastic molded body. The surface has two corresponding sides respectively provided with a lateral wall, and each lateral wall is provided with a plurality of partially broken sections. Two sides of each partially broken section are respectively formed with a positioning part, so that, when the body is pressed downwardly, the partially broken section is expanded to form a gap, by which the body's height is lowered. The positioning element is used to interconnect the two positioning parts of each partially broken section, and to enclose the partially broken section of the body when the body's arcuate shape is restored.

In implementation, the gap is in V shape.

In implementation, the positioning element is a plate, and the plate has one end fixed to one positioning part and another end connected to the other positioning part via a locking element.

In implementation, the positioning element is a plate, and the plate has one end integrally formed on one positioning part and another end connected to the other positioning part via a locking element.

The present invention will become more fully understood by reference to the following detailed description thereof when read in conjunction with the attached drawings.

### BRIEF DESCRIPTION OF THE DRAWINGS

FIG. 1 is a perspective view showing an embodiment of a vehicle fender structure for easy storage and transportation according to the present invention.

FIG. 2 is a schematic view showing the use of the vehicle fender structure for easy storage and transportation according to the present invention, where its body is pressed downwardly and flattened.

FIG. 3 is a schematic view showing the use of the vehicle fender structure for easy storage and transportation according to the present invention, where the arcuate shape of the body is restored by means of the use of the positioning element.

### DETAILED DESCRIPTION OF THE INVENTION

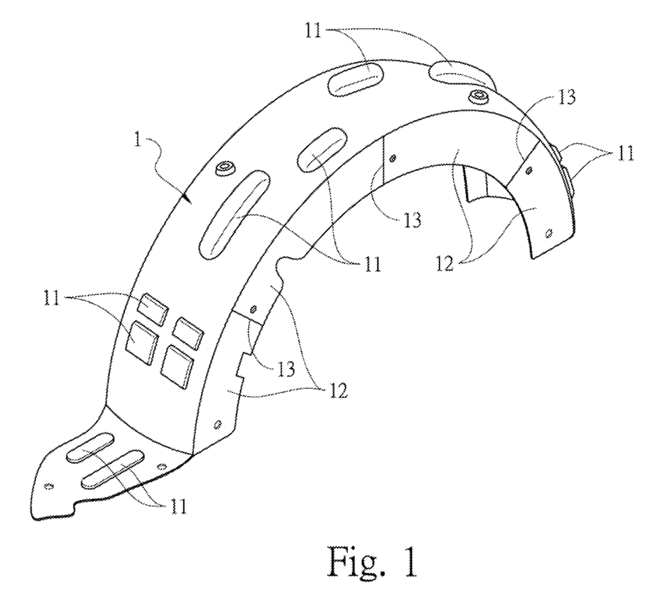

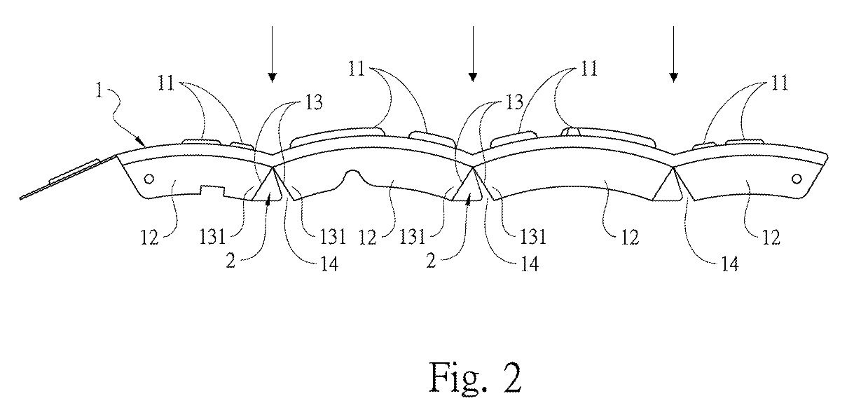

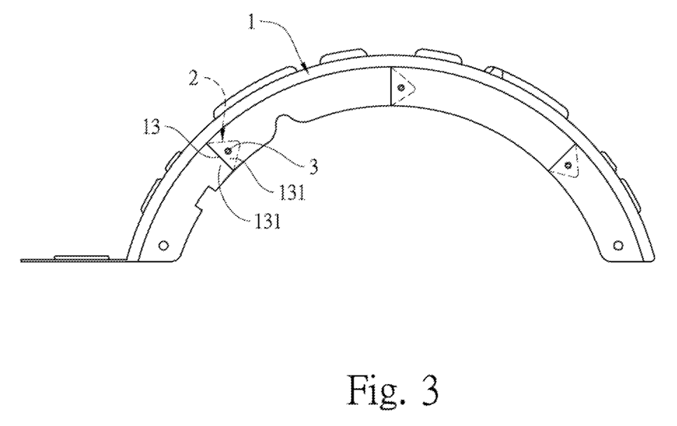

Please refer to FIGS. 1-3, which show an embodiment of a vehicle fender structure for easy storage and transportation according to the present invention. The vehicle fender structure comprises a plastic molded body 1 and a positioning element 2.

The body 1 is in an arcuate shape. The body 1 has a surface provided thereon with a plurality of protruding parts 11 that are of different sizes for strengthening the plastic molded body. The surface of the body 1 has two corresponding sides respectively provided with a lateral wall 12, and each lateral wall 12 is provided with a plurality of partially broken sections 13. Two sides of each partially broken section 13 of the body 1 are respectively formed with a positioning part 131.

The positioning element 2 is used to interconnect the two positioning parts 131 and to enclose the partially broken section 13 of the body 1 when the body's arcuate shape is restored.

In implementation, the positioning element 2 is a plate, and the plate has one end fixed to or integrally formed on one positioning part and another end connected to the other positioning part via a locking element 3. Alternately, above two positioning parts 131 also could be interconnected by other means, such as by means of binding them together or adhering them with each other.

Therefore, during the process of transportation, the height of the body 1 is lowered by pressing the body 1 downwardly to expand the partially broken section 13 to form a gap 14 that is in a V shape. When the vehicle fender structure is purchased by a consumer, the arcuate shape of the body 1 could be easily restored by using the positioning element 2 to interconnect the two positioning parts 131 and enclose the partially broken section 13. After that, the vehicle fender structure with the restored arcuate shape could be mounted by the consumer onto the vehicle.

By means of the structural design of providing the body 1 with partially broken sections 13, during the process of transportation or of storage before sale, it would be easy to flatten the body 1 by pressing the body 1 downwardly to make the body in a flattened shape instead of the original arcuate shape, so as to significantly reduce the space (especially in height) required to hold it. Therefore, under similar conditions, more products could be transported and stored. For a consumer, it is also easy to restore the arcuate shape of the body by using the positioning element 2 to enclose the partially broken section 13 for further mounting it onto the consumer's vehicle.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

In conclusion, according to above-disclosed descriptions, the present invention achieves the expected object to provide a vehicle fender structure for easy storage and transportation. It is novel and has industrial use.

What is claimed is:

1. A vehicle fender structure for easy storage and transportation, comprising:
a plastic molded body, which is in an arcuate shape and has an surface, where the surface is provided thereon with a plurality of protruding parts that are of different sizes for strengthening the plastic molded body, and has two corresponding sides respectively provided with a lateral wall; each lateral wall is provided with a plurality of partially broken sections, and two sides of each partially broken section are respectively formed with a positioning part, so that, when the body is pressed downwardly, the partially broken section is expanded to form a gap, by which the body's height is lowered; and
a positioning element, used to interconnect the two positioning parts of each partially broken section, and to enclose the partially broken section of the body when the body's arcuate shape is restored.

2. The vehicle fender structure for easy storage and transportation according to claim 1, wherein the gap is in V shape.

3. The vehicle fender structure for easy storage and transportation according to claim 1, wherein the positioning element is a plate, and the plate has one end fixed to one positioning part and another end connected to the other positioning part via a locking element.

4. The vehicle fender structure for easy storage and transportation according to claim 1, wherein the positioning element is a plate, and the plate has one end integrally formed on one positioning part and another end connected to the other positioning part via a locking element.
